(19) United States
(12) Patent Application Publication
(10) Pub. No.: US 2002/0085726 A1
(43) Pub. Date: Jul. 4, 2002

(54) Apparatus, system and method for capturing sound

(76) Inventor: Kenton Michael Fuqua, El Cajon, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/038,400

(22) Filed: Jan. 3, 2002

Related U.S. Application Data
(60) Provisional application No. 60/259,826, filed on Jan. 4, 2001.

(51) Int. Cl. H04B 3/00; H04R 3/00

(52) U.S. Cl. 381/111; 381/77

(57) ABSTRACT

A sound capture device efficiently and accurately converts sound pressure waves forming a sound signal into an electrical signal. Power signals are received on a supply conductor while electrical signals are transmitted through a signal conductor. A multiple stage amplifier is co-located with the transducer and amplifies the electrical signal prior to transmission through a transmission interface housing the signal conductor. Multiple transducers can be used at a separation distance in accordance with sound travel around a human head to increase phase information of the captured sound.

### RELATED PATENT APPLCIATIONS

This patent application claims the benefit of related U.S. provisional patent application entitled “Sound Capture Device and Method”, Serial No. 60/259,826, filed on Jan. 4, 2001 and which is included in its entirety in Appendix A.

### BACKGROUND OF THE INVENTION

The invention relates in general to sound capture and more specifically to a system, apparatus and method for capturing and processing a sound signal.

Sound capture devices convert acoustical sound pressure waves into electrical or optical signals. Examples of conventional sound capture devices include microphones and other types of acoustical transducers where a transducer produces an electrical current or voltage in response to a received sound pressure wave.

Sound capture devices are used in variety of systems and devices in areas such as communication, live concerts, sound recording, sound amplification and broadcasting, television, film, surveillance and sonar. In most applications, it is advantageous to capture the sound with the highest possible accuracy and without noise. For example, in applications involving the recording or amplification of music, great efforts are typically taken to properly position microphones. Further, a protected sound booth is often utilized to reduce noise due to external sources and to otherwise maintain a high signal to noise ratio of the captured sound. Other examples of applications requiring accurate capture of sound include communication and voice recognition systems. Although, it is often difficult to control the environment in these systems, the quality of the captured sound can be improved by using a sound capture device with the appropriate characteristics and sound processing the captured signal.

Conventional sound capture devices are limited in performance and are often the “weakest link” in many recording, communication and other systems utilizing a sound capture device. Some techniques can be used to improve the quality of a captured signal by, for example, filtering, amplifying, equalizing, or otherwise processing an existing signal. Performance of the system, however, is still limited by the quality of the original captured sound signal.

Important performance characteristics of a sound capture device include characteristics related to frequency response of the sound capture device, the signal-to-noise ratio of the captured signal and phase information of the captured signal. The frequency response of the sound capture device affects the relative amplitude of the sound signal at different frequencies. The signal to noise ratio is the ratio of amplitude of the desired signal as compared to the level of the noise. Although noise may exist from external sources, noise produced by the sound capture device and other system components should be minimized.

Conventional microphones are further limited in performance related to phase information. For example, omnidirectional microphones are intended to receive signals at all angles relative to the axis of the microphone. The frequency response of conventional omnidirectional microphones, however, is not the same at all the angles at which sound is received. The off-axis performance of a conventional omnidirectional microphone is significantly limited compared to the on-axis performance. In other words, sound signal that are received off-axis are not captured in the same way that sounds received on-axis are captured, resulting in lost or distorted phase information of the captured sound.

Therefore there is need for an efficient apparatus, system and method for maximizing the signal-to-noise ratio and amount of phase information of a captured sound signal when converting sound energy to an electrical signal.

### BRIEF DESCRIPTION OF THE DRAWINGS

FIG. 1 is a block diagram of a sound capture system in accordance with the exemplary embodiment of the invention.

FIG. 2 is a block diagram of a top view of the sound capture device in accordance with the exemplary embodiment of the invention where the sound capture module includes two transducers.

FIG. 3 is a block diagram of a sound capture device connected within an exemplary studio recording system.

FIG. 4 is a schematic diagram of a suitable implementation of a channel amplifier connected to the transducer in accordance with the exemplary embodiment of the invention.

FIG. 5 is a schematic diagram of a suitable implementation of the power supply in accordance with the exemplary embodiment of the invention.

FIG. 6 is a block diagram of the sound capture device connected within a an exemplary implementation of a speech recognition system.

FIG. 7 is a flow chart of a method of capturing sound in accordance with the exemplary embodiment of the invention.

FIG. 8 is graphical representation of a frequency response of the exemplary sound capture device for different reception angles relative to an axis of the reception pattern.

### DETAILED DESCRIPTION OF THE PREFERRED EMBODIMENTS

In an exemplary embodiment of the invention, at least one transducer converts a sound signal into an electrical signal that is amplified by an amplifier co-located with the transducer. The resulting amplified electrical signal is transmitted on a signal conductor in a transmission interface, such as a transmission interface cable or pair of cables, while power is supplied to the amplifier and the transducer through a separate supply conductor in the transmission interface. Some other features of the exemplary embodiment include a short transmission path from the transducer to the amplifier and a multiple stage amplifier. Various other embodiments may incorporate some or all of the features discussed herein in addition to other features not explicitly emphasized.

The resulting sound capture apparatus, system and method has several advantages over conventional microphones. For example, the amplified signal produced at the output of the transmission interface does not experience the same signal degradation as a conventional microphone system. The amplified electrical signal is not transmitted on the same conductor as the conductor used for supplying power to the transducer and noise present on the supply conductor cannot directly corrupt the amplified electrical signal. Further, the amplified electrical signal can be adjusted to have an amplitude much greater than any noise present in and around the sound capture system. The signal-to-noise ratio, therefore, can be maintained at a significantly high level as the signal is transmitted through the transmission interface. Also, the close proximity of the amplifier to the transducer allows the signal to be amplified with minimal interference from external noise sources that could potentially degrade the signal prior to amplification. In addition, the short transmission path from the transducer to the amplifier minimizes signal loss prior to amplification. The resulting high quality signal at the output of the sound capture system can be adjusted to a line level voltage (approximately 2.0-6.0 volts), eliminating the need for additional amplification prior to further processing for many applications. For, example, in recording studio applications, the amplified electrical signal produced at the output of the transmission interface can be connected to the “Line Level” input ports on studio equipment rather than the “Low Level” or “Microphone” input ports that typically provide amplification to a line level amplitude before further signal processing or recording.

As discussed further below, phase information is also accurately captured and retained by the sound capture system. Another feature of the exemplary embodiment includes the use of two transducers spaced by a separation distance in accordance with sound travel around a human head. The transducers are positioned such that the separation distance simulates the time delay experienced from the front of a human head to the ears when the head is facing the sound source and therefore, to simulate the phase differential as experience at the ears. Further, the transducers can be angled toward the sound source to simulate the sound reception of the human ears.

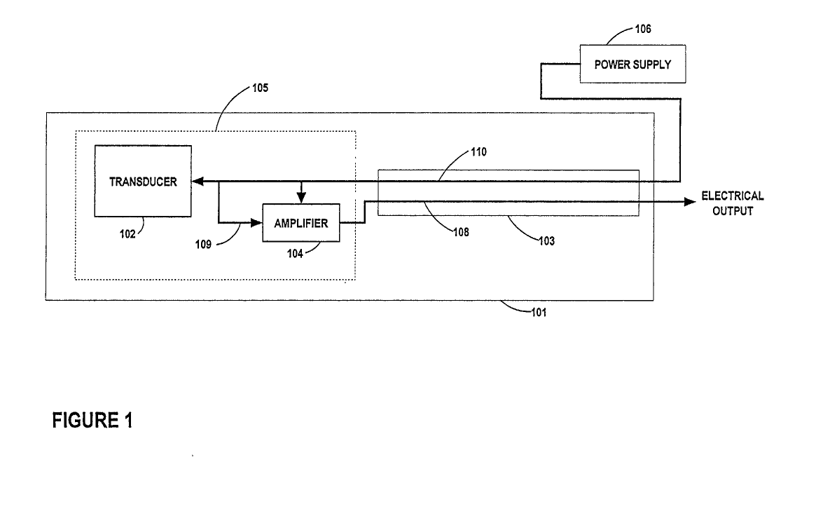

FIG. 1 is a block diagram of a sound capture system 100 in accordance with the exemplary embodiment of the invention. The sound capture system 100 can be utilized in a variety of applications including music and sound recording, communications, broadcasting, sound amplification, voice recognition systems, sonar and other applications where sound is converted from a sound pressure wave to an electrical signal. The sound capture device 101 includes at least one transducer 102 connected to an amplifier 104. The at least one transducer 102 and amplifier 104 form a sound capture module 105 that is connected to a transmission interface 103. The transmission interface 103 provides transmission paths for outgoing electrical signals from the sound capture module 105 and for incoming power to the sound capture module 105. The transmission interface 103 includes at least one signal conductor 108 and one supply conductor 110 and may include several other conductors, shields, or insulation. The transmission interface 103 can be any type of cable, wire, transmission line or connector that includes at least one signal conductor and at least one supply conductor. The transmission interface 103 may include a single housing or cable that encases the signal conductor 108 and the supply conductor 110. In the exemplary embodiment, however, the transmission interface 103 includes a supply cable and a signal cable where the supply cable includes two supply conductors 110 and a common conductor and the signal cable includes two signal conductors 108 as well as a grounded shield.

In the exemplary embodiment, the sound capture device 101 is an integrated unit including the sound capture module 105 and transmission interface 103. In certain circumstances, however, the sound capture module 105 may be connected to the transmission interface 103 through a connector allowing the sound capture module 105 to be disconnected from the transmission interface 103.

The transducer 102 produces an electrical signal in accordance with a sound signal received at an input of the transducer 102. The transducer 102 may be any one of several types of transducers or combinations of transducers. Examples of suitable transducers include condenser, dynamic, and electret elements or microphones. The transducer 102 or combination of transducers (102) provide a mono, binaural, stereo, multiple channel or phased-array electrical signal. The relationship between the electrical signal and received sound signal may or may not be linear depending on the type of transducer, the level of sound signal and operable frequency range. The amplitude of the electrical signal in relation to the sound signal depends on a variety of factors. A typical condenser element produces an electrical signal having a voltage of 0.13 volts from a sound signal having a sound pressure level of 96 decibels (dB), for example.

The electrical signal produced at the electrical signal output of the transducer 102, is transmitted through an internal conductor 109. The internal conductor 109 is as short as possible in the exemplary embodiment and may comprise a short section of conductor or trace on a printed circuit board. Another example of a suitable internal conductor 109 includes a direct connection between the contact comprising the electrical signal output of the transducer 102 to the first component of the amplifier 104. Other examples include short lengths of cable, wire, and conductive tape or ribbon. The internal conductor 109 is shorter than the signal conductor length of the signal conductor 108 and in some circumstance is less than half the signal conductor length. In other circumstance the internal conductor length is less than 1/10th the signal conductor length. In still other instances, the internal conductor length is less than 1/100th of the signal conductor length.

The electrical signal is received at an amplifier input of an amplifier 104 and amplified to produce an amplified electrical signal. In the exemplary embodiment, the amplifier includes multiple amplification stages. A suitable configuration of the amplifier includes the use of two stages where each stage provides approximately 15 dB of power gain. Any number of amplification stages may be used, where the number of amplification stages depends on factors such as the amplitude of the electrical signal, the characteristics of each amplification stage, the characteristics of the transmission interface 103 and the desired amplitude of the amplified electrical signal.

The amplified electrical signal is transmitted through the transmission interface 103 on the signal conductor 108. Where multiple transducers 102 are used, the electrical signal from each transducer 102 is amplified by a channel amplifier and transmitted through a separate signal conductor 108. The transmission interface 103 provides a connection to the desired destination of the amplified electrical signal. If the sound capture device 101 is used in a musical recording system, for example, the transmission interface 103 is connected to a “line level” input of the recording equipment that may include an equalizer, filter, analog to digital (A/D) converter, or other signal processing equipment as well as analog or digital recorders. In applications such as recording studios and live concerts, a suitable transmission interface 103 includes several feet of shielded signal cable that includes the supply conductor 108 and a separate supply cable that includes the supply conductor 110. Where the sound capture device 101 is used in a communication system, the transmission interface 103 may have a length on the order of a few inches or less and may include two or more wires connected to audio processing or other circuitry in a communication device.

The power supply 106 provides electrical power to the transducer 102 and the amplifier 104 through the transmission interface 103. In the exemplary embodiment, the power supply 106 is a direct current (DC), low noise power supply that provides a positive supply voltage regulated to approximately 14 volts and a negative supply voltage regulated to approximately −14 volts relative to a common voltage such as ground. As discussed above, the transmission interface 103 includes two supply conductors 110 as well as a common conductor in the exemplary embodiment. The positive supply voltage is provided to the transducer module 105 through one of the supply conductors 110 and the negative supply voltage is provided through the other supply conductor 110.

Some of the advantages of the sound capture device 101 over conventional microphones, therefore, result from the co-location of the transducer 102 and the amplifier 104. By utilizing an internal conductor 109 having a relatively short length, less noise is introduced to the electrical signal. Further, a relatively short length minimizes signal loss from the transducer 102 to the amplifier 104. Most conventional systems, particularly music recording systems, do not amplify the electrical signal produced by the microphone until after a relatively long transmission path from the microphone resulting in the amplification of a weak and noisy signal. Accordingly, co-location of the amplifier 104 to the transducer 102 includes minimizing the length of the transmission path between the transducer 102 and the amplifier 104 and does not necessarily require the amplifier 104 and the transducer 102 to be mounted within a single housing.

The sound capture device 101 can be used in a variety of applications and systems. The high quality of the electrical signal produced by the sound capture device 101 as compared to conventional microphones allows the sound capture device 101 to provide improved performance in any system utilizing microphones or other sound capture devices. Some examples of systems where the sound capture device 101 and method can be used include applications related to music recording, sound recording, communications, cellular telephone communication, live performances, sonar, surveillance, multimedia recording, video cameras, film production, television production and broadcasting, radio broadcasting, telematics, speech recognition and voice response. Particularly, significant advantages can be realized in music recording systems and speech recognition systems as discussed below.

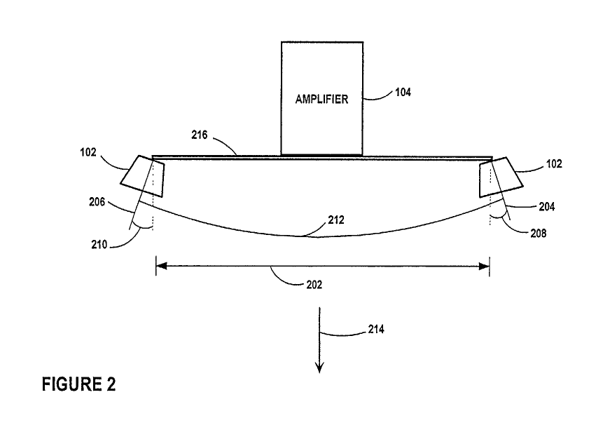

FIG. 2 is a block diagram of a top view of the sound capture module 105 in accordance with exemplary embodiment of the invention where the sound capture device 101 includes two transducers 102. The transducers 102 are connected to the amplifier 104 through the internal signal conductor 109. In the exemplary embodiment, the amplifier 104 includes circuitry for each channel and, therefore, includes a set of amplification stages for each transducer 102.

The transducers 102 are mounted to a support arm 216 and positioned at a separation distance 202 in accordance with sound reception at human ears on a human head facing a sound source. The support arm 216 can have a variety of shapes and sizes. In the exemplary embodiment, the support arm 216 has a width less than ¼ of an inch and a shape that minimized interference with the sound being captured. Also, the support arm 216 can be eliminated in some situations.

The separation distance 202 is selected to simulate sound travel to human ears around a human head facing a sound source. The direction of the sound source relative to the sound capture module 105 is indicated with arrow 214 in FIG. 2. For an average person, the linear distance through the skull between the two ears is approximately 7 to 8 inches. A substantial portion of the sound energy of a sound wave incident on the human head does not travel through the head and travels along the contour of the skull to the ears. For sound waves traveling toward the head at any angle up to 180 degrees from the direction the head is facing (module axis) 214, the effective distance between the two ears that the sound waves must travel is approximately equal to the radius of the head multiplied by n (pi). Accordingly, in the exemplary embodiment, the separation distance 202 between the two transducers 102 is 12 inches. In certain instances a separation distance 202 anywhere between 10 and 14 inches is appropriate. In other instances, a separation distance 202 between 11 and 13 inches is appropriate.

Each transducer 102 is positioned at an angle 208, 210 to the axis 214 from the center of the sound capture module 105 to the sound source producing the captured sound. The sound capture module 105, therefore, is positioned such that a line connecting the two transducers 102 is perpendicular to the direction a human head would face to listen to the sound. Each transducer 102 has an axis 204, 206 along the main lobe of a sound reception pattern of the transducer 102. The angle 212 between the transducer axis 204, 206 is chosen to simulate the sound reception at human ears. In the exemplary embodiment, the angles 208, 210 from the each transducer axis 204, 206 to the module axis 214 are both approximately 15 degrees. The angle 212 between the two transducer axis 204, 206 is therefore, approximately 30 degrees in the exemplary embodiment. In certain circumstances, the angles 102, 210 may have different values. Also, in certain circumstances the angles 208, 210 may be between 5 and 25 degrees. In other circumstances, the angles 208, 210 are anywhere between 10 and 20 degrees.

Positioning the transducers 102 at the angle 212 allows better off-axis performance than conventional microphones. The angle 212 may have any value including angles 212 from zero to ninety degrees. In addition, the specific angle 212 or angles 208, 210 can be adjusted to provide various sound qualities.

The positioning of the transducers 102 allows sound capture that retains the phase information of the sound signal. In recording applications, the sound signal is more accurately reproduced during playback due to the retention of phase information as compared to conventional recording systems and microphones. A reproduced sound signal from the recorded sound signal includes phase angle information and imaging at the same ratio as experienced by a person listening to the original sound signal, live. The result is a more realistic reproduction of recorded sound than is possible with conventional microphone devices.

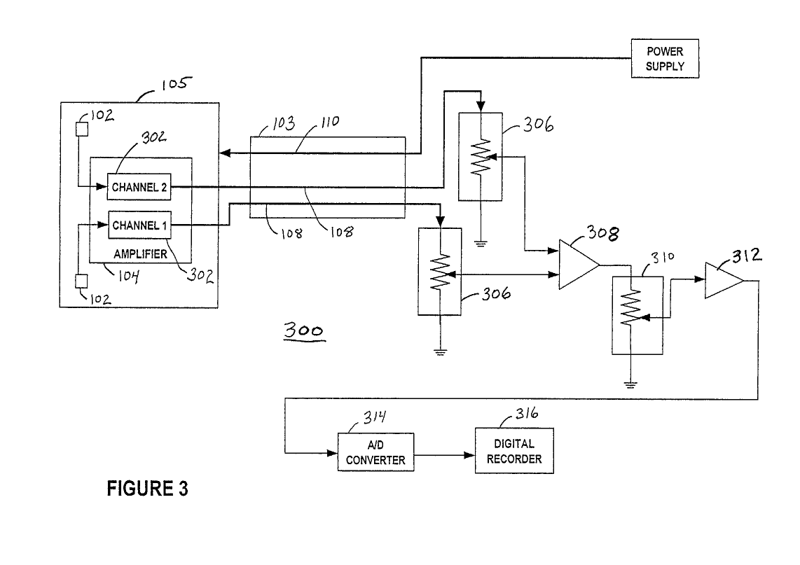

FIG. 3 is a block diagram of a sound capture device 101 connected within an exemplary studio recording system 300. Two transducers 102 in the sound capture module 105 produce electrical signals in accordance with received sound pressure waves. The exemplary studio recording system 300 includes components to process and record two channels such as a left channel and right channel. In the exemplary embodiment, therefore, the amplifier includes two channel amplifiers 302 where one channel amplifier 302 is used for a left channel and another channel amplifier 302 is used for a right channel. Any number of channel amplifiers 302 can be used, however.

Each channel amplifier 302 amplifies the electrical signal produced by one of the transducers 102. In applications utilizing more that two transducers 102, additional channel amplifiers 302 may be used for each electrical signal. The amplifier 104 amplifies the electrical signals to a line level voltage on the order of 26 volts RMS (Root Mean Square). The resulting amplified electrical signals are transmitted through the transmission interface 103 on two signal conductors 108. In the exemplary embodiment, the signal conductors 108 are housed in a separate cable from the supply conductors 110 connected between the sound capture module 105 and the power supply 106. All of the conductors 108, 110, as well as other conductors, can be housed within a single cable, however. The power signals received at the sound capture module 105 are distributed to the transducers 102 for bias voltage and to the components within the amplifier 104. As explained above, the power signals included a positive and negative voltage supply.

A volume control 306 provides a mechanism for adjusting the amplitude of each amplified signal received from each of the channel amplifiers 302. An example of suitable volume control 306 is a potentiometer. Those skilled in the art will recognize the various types of volume controls that can be used. For example, a single potentiometer can be used as a volume control for both channels. The volume control 306 may include additional components in certain circumstances.

A summing amplifier 308 combines the amplitude adjusted electrical signal forming the two channels to produce a master electrical signal that includes both channels. The master electrical signal can be further adjusted by a master volume control 310.

The adjusted master electrical signal is further amplified in a line amplifier 312. An example of suitable gain of the line amplifier is 10 dB. An analog to digital converter (A/D converter) 314 converts the amplified master electrical signal into a master digital signal. A variety of A/D converters 314 can be used. For example, the A/D converter 312 can provide 1, 16, 20 or 24 bit digital signals. The digital recorder 316 records the digital signal.

Those skilled in the art will readily apply the teachings herein to a variety of recording systems. Examples of other recording systems include systems using equalizers or other processors to further process or modify the captures sound signal and systems using analog recorders and systems.

Compared to a conventional microphone in a typical professional studio recording application, the sound capture device 101 as used in a typical recording application produces a much higher quality signal for recording. For example, a 30-degree angle 212 and 12 inch separation distance 202 allows for a more realistic reproduction of phase information and better off-axis performance than conventional microphones. Also, the resulting output signals have a much higher amplitude than signals produced by conventional microphones. Line level signals, for example, can be provided at 2 to 6 volts as compared to 0.002-0.01 volt amplitudes of conventional microphone signals received at the recording equipment. The higher amplitudes result in higher signal-to-noise ratios of the recorded signal.

In addition, in the exemplary recording system 300 the need for various components used in conventional systems is eliminated. For example, line preamplifiers, equalizers, limiters, effects pre-amplifiers, phase amplifiers and pan pots are typically required in a conventional recording system but do not need to be used in the exemplary system 300. These components can become unnecessary because the sound capture device 100 provides a much higher quality electrical signal to the volume control 306 than is provided by the conventional microphones and microphone pre-amplifiers. These components, however, can be used alone or in combination with other embodiments of the present invention to provide higher sound quality provided by conventional systems.

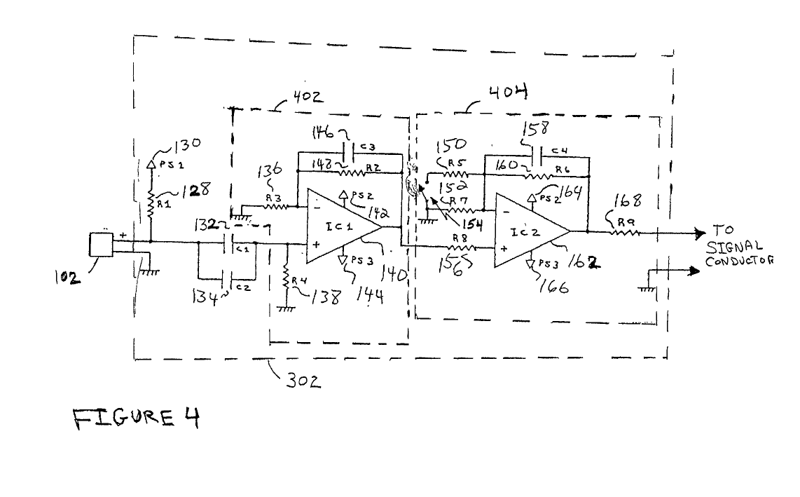

FIG. 4 is a schematic diagram of one implementation of the transducer 102 and the channel amplifier 302 in accordance with the exemplary embodiment of the present invention. Each channel amplifier 302 includes a plurality of amplification stages 402, 404. Although two amplification stages 402, 404 are used in the exemplary implementation of the channel amplifier 302, any number of amplifier stages 402, 404 can be used. Also, the amplification stages 402, 404 may have the same or different signal gains. Examples of suitable gain values include gains greater than one for all amplification stages 402, 404 and gains that are approximately 15 dB for each amplification stage 402, 403. The gain of the amplification stage 402, 403 depends on a variety of factors such as the amplitude of the electrical signal received from the transducer, the number of gain stages (402, 403), the desired amplitude of the amplified electrical signal, and power and size limitations of the circuitry.

In this implementation, the transducer 102 is a condenser element such as a P9959-ND or WM-60 AY capsule. The transducer (condenser element) 102 is connected to a resistor 128 and two capacitors 132 and 134. An example of a suitable value for the resistor 128 is 4.99 kilo-ohms. Examples of suitable capacitors include a 0.4 micro-Farad/200 volt polypropylene capacitor for one capacitor 132 and a 0.01 micro-Farad/50 volt polystyrene capacitor for the other capacitor 134. The capacitors 132, 134 are connected to the resistor 138 and the positive input of amplifier 140. The negative input of the amplifier 140 is connected to two resistors 136, 148 and to the capacitor 146. The output of the amplifier 140 is connected to a capacitor 146 and two resistors 148 and 156. An example of suitable values for the resistors includes 20 kilo-ohms for resistor 138, 2 kilo-ohms for resistor 136, 10 kilo-ohms for resistor 148, and 499 ohms for resistor 156. The capacitor 146 is a 15 pico-Farad/50 volts polystyrene capacitor in this implementation. The amplifier 140 and associated circuitry forms the first amplification stage 402.

The resistor 156 is connected to the positive input of another amplifier 162 while the negative input of the amplifier 162 is connected to three resistors 152, 150, 160 and a capacitor 158. Examples of suitable amplifiers 140 and 162 include the OPA 627 AP amplifier made by Burr Brown and other similar high quality amplifiers. A switch 154 is connected between two resistors, 150, 152. The output of amplifier 162 is connected to the resistor 160 and the capacitor 158, as well as to the resistor 168, which is connected to the signal conductor 108. Examples of suitable values for the resistors include 4.99 kilo-ohms for resistor 150 and resistor 152, 10 kilo-ohms for resistor 160, and 249 ohms for resistor 168. A 15 pico-Farad/50 volt polystyrene capacitor is an example of a suitable capacitor 158.

The power supply 130 converts a power supply received from power supply 106 to approximately 6 volts for bias power for the transducers 102. The other power supplies 142, 144, 164 and 166 provide operating power for the amplifiers 140 and 162. In the exemplary implementation of the amplifier 104, two of the power supplies 142, 164 are approximately equal to a positive 14 volts (+14 V) and the other power supplies 144, 166 are approximately equal to a negative 14 volts (−14 V). Depending on the application, different operating power supplies can be used.

During operation of the sound capture device 101, the electrical signal from the transducer 102 is coupled to through the capacitors 132, 134 to the amplifier 140. The capacitors 132, 134 block any DC component created by the power supply 130 while allowing passage of the electrical signal from the transducer 102. The capacitors 132, 134 and the resistor 138 form a filter that minimizes the DC components of the electrical signal. As explained above, the amplifier 140 provides a first amplification stage having a gain of approximately 15 dB. The electrical signal is transmitted through the resistor 156 to the second amplifier 162. The capacitor 146 and the resistors 136, 148 forming a voltage-dividing network are adjustable to change the feedback signal to amplifier 140.

At the second amplification stage 404, the amplifier 162 provides approximately 15 dB of gain to the signal produced by the first amplification stage 402. The resulting amplified electrical signal is transmitted through resistor 168 to the signal conductor 108 and has an amplitude approximately 30 dB higher than the electrical signal produced by the transducer 102. Therefore, in this implementation of the exemplary embodiment, two amplification stages 402, 404 each provide approximately 15 dB gain to amplify the electrical signal by a total gain of approximately 30 dB. Additional amplification stages (402, 404) can be used, for example, to distribute amplification between a larger number of amplification stages or to increase the total gain of the amplifier 104. By using multiple amplification stages rather than one, the system produces a more accurate electrical signal.

In this embodiment, the feedback loop for amplifier 162 comprises resistors 150, 152 and 160 and capacitor 158. A switch 154 allows the gain of the amplifier 104 to be adjusted. If the switch 154 is closed, resistors 150 and 152 act in parallel and provide approximately 14 dB of gain. This situation can be useful for low volume level recordings. If switch 154 is open, only resistor 152 remains in the circuit and in this example, approximately 9.5 dB of gain is provided, which can be used when high volume level recording applications are desired. A line-level voltage of approximately 2 to 6 volts RMS (Root Mean Square) is coupled to the signal conductor 108 and provides a high quality signal for recording or for other purposes.

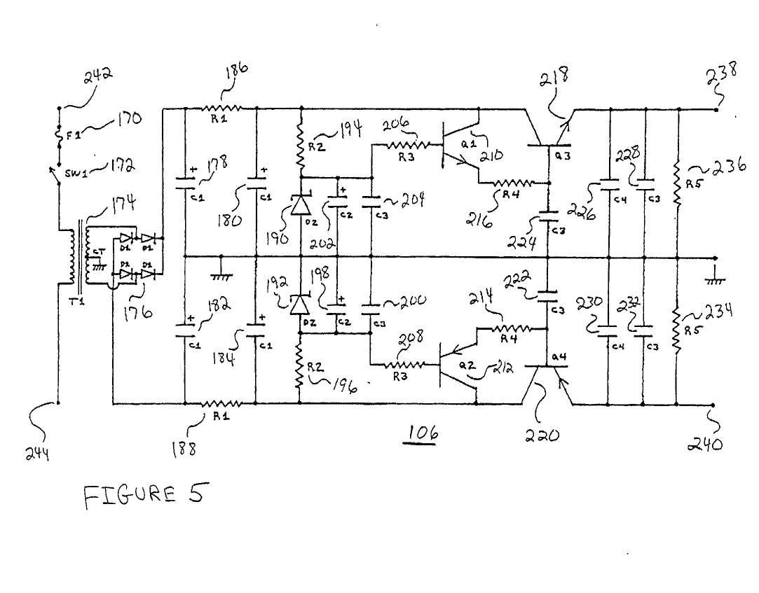

FIG. 5 is a schematic diagram of an exemplary implementation of the power supply 106 in accordance with the exemplary embodiment of the invention. Based on the teachings herein, those skilled in the art will readily recognize other implementations and techniques for providing the appropriate power signals to the sound capture module 105.

A resistor 168 provides an output buffer for current limiting protection in a short circuit situations that may occur, for example, with the use of a faulty cable. In this exemplary implementation of the power supply 106, a fuse 170 is connected to a switch 172 that is connected to the primary winding of a transformer 174. A suitable transformer 174 is a 25 volt AC center-tap transformer. An example of a suitable fuse 170 is a 250 micro-amp/250 volt fuse. A 3 amp/250 volt switch can be used for the switch 172. The secondary winding of transformer 174 is connected to a 4-way bridge rectifier 176 that includes four IN 4944 diodes, for example. The rectifier 176 is connected to two resistors 186, 188 and two capacitors 178, 182. Two resistors 186, 188 are connected to two capacitors 180, 184, respectively, and to two resistors 194, 196. Examples of suitable values for the capacitors 178, 180, 182, 184 include 3,300 micro-Farad/35 volt capacitors. The resistors 186, 188 are 10 ohms/2 watt resistors, in this exemplary implementation. A resistor 194 is connected to a zener diode 190, two capacitors 202, 204 and a transistor 210. A resistor 196 is connected to zener diode 192, capacitors 198 and 200 and transistor 212. A resistor 206 is connected between the capacitor 204 and the transistor 210. Examples of suitable capacitors 198, 202 include 2200 micro-Farad 25 volt capacitors. A 0.1 microFarad/200 volt capacitor is suitable for capacitors 200, 204. An example of a suitable diode for the zener diodes 190, 192 is a 15 volt diode such as the IN 5245B zener diode. Suitable resistors 194, 196 are 4.99 kilo-ohms/0.25 W resistors. A resistor 208 is connected between the capacitor 200 and the transistor 212. The transistor 210 is also connected to another transistor 218 and a resistor 216, while transistor 212 is connected to transistor 220 and resistor 214. In this exemplary implementation, transistor 210 is a KN 4401 transistor, and transistor 212 is a KN 4403 transistor, transistor 218 is a MJE 182 transistor and transistor 220 is a MJE 172 transistor. A suitable value for the resistors 206, 208 is 100 ohms while 20 ohms can be used for the other resistors 214, 216. The capacitors 222, 224 are connected to each other in series, and are connected between two transistors 218, 220. The transistor 218 is connected to two capacitors 226, 228 and a resistor 236. The transistor 220 is connected to two capacitors 230, 232 and a resistor 234. An example of suitable capacitor for use as the capacitors 222, 224 is a 0.1 micro-Farad/200 volt capacitor. The resistors 234, 236 are 10 kilo-ohms/0.25 watts in this implementation. An example of suitable capacitors 226, 230 includes 4 micro-Farad 200 volt capacitors, while 0.1 micro-Farad 200 volt capacitors can be used for the other capacitors 228, 232.

During operation of the exemplary implementation of the power supply 106, a standard wall outlet power supply of 120 volts AC (not shown) is received at the power supply 106 across node 242 and node 244. The transformer 174, switch 172 and the 4-way bridge rectifier 176 convert the 25 volts AC to 17.625×2 volts DC. In other embodiments, other input voltages such as 220 volts AC can be utilized along with an appropriate transformer 174. In this exemplary implementation, the capacitors 178, 180, 182, 184 and resistors 186, 188 provide filtering for the DC signal. After undesired spurious signals and other noise is removed, the signal passes through the zener diodes 190, 192 and resistors 194, 196, which provide a 15 volt reference voltage. The signal then passes through capacitors 198, 200, 202 and 204 in order to eliminate noise from the voltage reference. The signal passes to transistors 210, 212, 218 and 220 for final regulation of the voltage which, in exemplary embodiment, is approximately 13.8 volts. The resistors 206, 208, 214, 216 provide stabilization for the circuit. In addition, the capacitors 222, 224 provide dampening to increase higher frequencies because of the drop off in high frequencies caused by the transistors. Other capacitors 226, 228, 230, 232 also provide dampening. In this exemplary embodiment, the final regulated power output at node 238 is +13.8 volts DC and at node 240 is −13.8 volts DC. The final regulated power output can vary depending on the specific application. The resistors 234, 236 act as bleed resistors such that the circuit is discharged to 0 volts if the standard wall outlet power supply (not shown) is unplugged.

As discussed above, the sound capture device 101 can be used in a variety of applications and systems. The improved quality of the electrical signal produced by the sound capture device 101 as compared to conventional microphones allows the sound capture device 101 to provide improved performance in any system utilizing microphones or other sound capture devices.

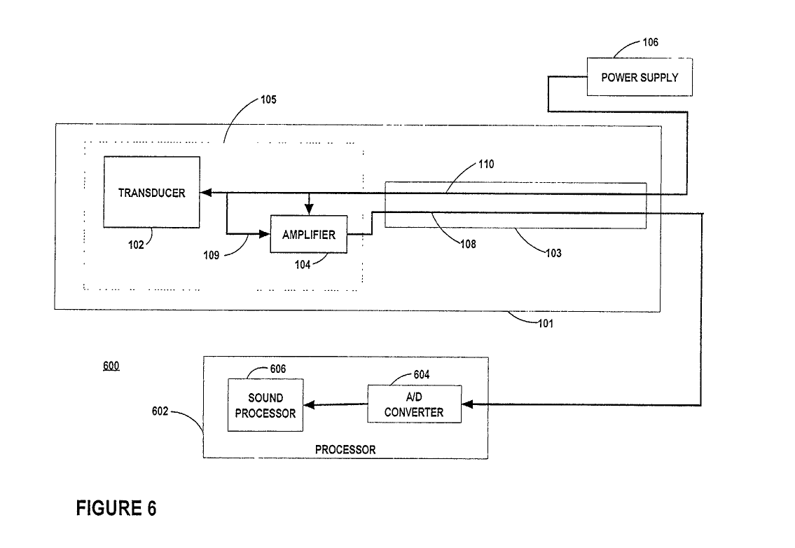

FIG. 6 is a block diagram of the sound capture device 101 connected within a speech recognition system 600 in accordance with the exemplary embodiment of the invention. Conventional voice response and speech recognition systems are currently experiencing difficult adoption by the marketplace due to, at least in part, poor performance and difficult system initialization. Elaborate sound processing and correction techniques are being developed to improve the performance of conventional speech recognition systems. These systems, however, are limited by the quality of the original electrical signal and, therefore, by the performance of the microphone.

The performance of speech recognition or voice response systems can be greatly improved by using the sound capture device 101 to produce a high quality electrical signal. As shown in FIG. 6, the sound capture device 101 can be connected to a computer 602. In the exemplary speech recognition system 600, the sound capture device 101 operates as described above in reference to FIG. 1 and includes a single unidirectional transducer 102. In certain circumstances, however, it may be advantageous to use multiple transducers 102 or transducers having different reception patterns such as omnidirectional transducers. Although the transducer 102 is a condenser element in the exemplary implementation of the speech recognition system 600, the transducer 102 may be any other type of transducer such as, for example, a dynamic, electret or phased array device.

The electrical signal produced by the transducer 102 is amplified and transmitted through the signal conductor 108 to a processor 602. As explained above, power signals are received through a supply conductor 110 within a supply cable of the transmission interface 103 in the exemplary embodiment.

In the exemplary embodiment, the processor 602 is a computer that includes hardware and software. The processor 602, however, can be any type of processor, computer, computer processor, microprocessor, or processor arrangement including appropriate circuitry, memory, connections, interfaces and code for performing the functions described. Software code running on the processor 602, facilitates the sound capture and processing as well as facilitating the overall functionality of the processor.

An audio interface, such as sound card, within the processor 602 receives the line level electrical signals through the signal conductor 108. The analog to digital converter (A/D converter) 604 converts the amplified electrical signal into a digital signal.

The digital signal is processed by the sound processor 606 to extract the appropriate information. The sound processor 606 is speech recognition circuit 606 implemented in hardware and software running on the processor 606 in the exemplary embodiment. The sound processor can be any type of circuit, module or software that can process the digital signal to obtain the desired information. Examples of applications of the speech recognition system 600 include computer control, voice activated word processing, voice controlled systems such as in-vehicle control systems. Those skilled in the art will recognize the numerous other applications for the speech recognition system 600.

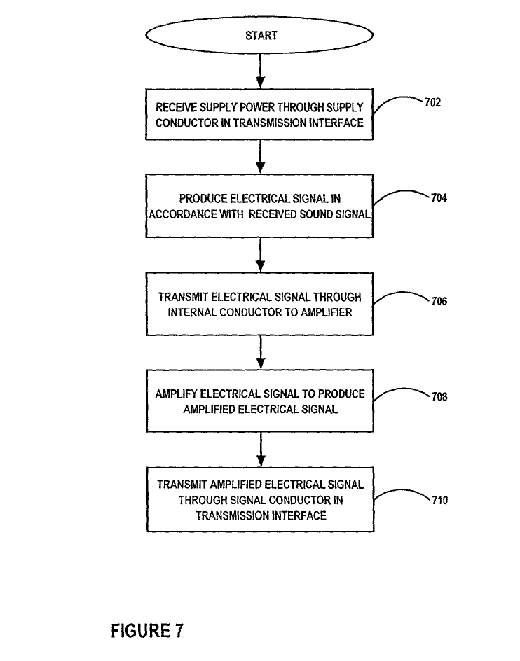

FIG. 7 is flow chart of a method of capturing sound in accordance with the exemplary embodiment of the invention. In the exemplary embodiment, the method is performed on the sound capture system 100 described above. The method, however, can be performed on any appropriate system using any combination of hardware, firmware, software.

At step 702, supply power is received through the supply conductor 110 in the transmission interface at the sound capture module 105. In the exemplary embodiment, a positive supply and a negative supply are received on separate conductors, processed and distributed to the transducer 102 and the amplifier 104 at the appropriate voltage level and quality.

At step 704, the transducer 102 produces an electrical signal in accordance with a received sound pressure wave. The electrical signal has an amplitude on the order of micro-volts in the exemplary embodiment.

At step 706, the electrical signal is transmitted through the interface conductor 109 to the amplifier 104. In the exemplary embodiment, the internal conductor length is as short as possible in order to minimize signal loss and signal degradation due to external noise sources.

At step 708, the electrical signal is amplified in the amplifier 104 to produce an amplified electrical signal. The amplified electrical signal has an amplitude on the order of 2 to 6 volts RMS in the exemplary embodiment and is an appropriate line level voltage.

The signal is transmitted through the signal conductor 108 in the transmission interface at step 710. The signal conductor 108 has a signal conductor length greater than an internal conductor length of the internal conductor 109. In the exemplary embodiment, the transmission interface 103 include two separate cables where one cable includes one or more signal conductors 108 and the other cable includes one or more supply conductors 110 as well as other shields and common conductors. The transmission interface, however, may include any combination of cables, wires, conductors that provide adequate signal isolation between the signal conductor 108 and the supply conductor 110.

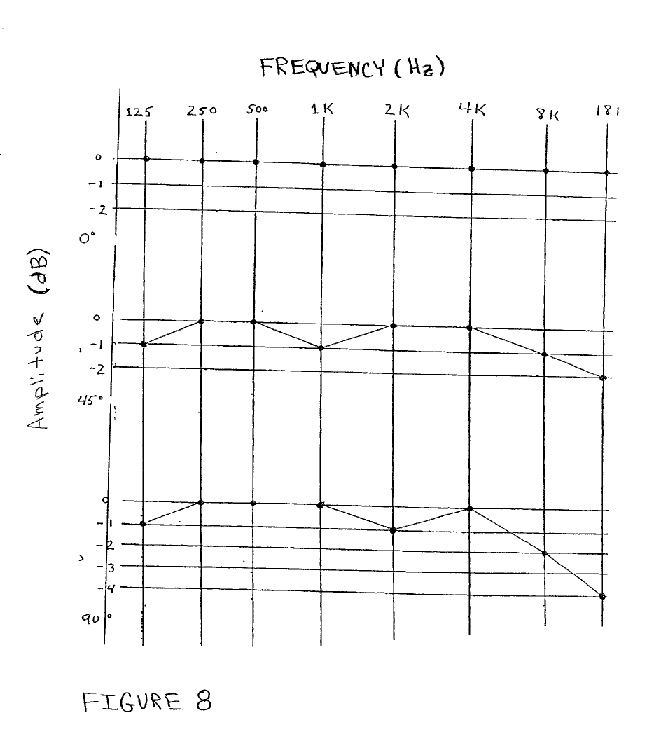

As discussed above, one of the advantages provided by the exemplary embodiment of the sound capture device 101 is that it offers superior off-axis performance as compared to conventional microphones. FIG. 8 is a graphical representation of the performance of the sound capture device 101 in accordance with the exemplary embodiment of the invention. Amplitude as a function of frequency is shown for 0 degrees, 45 degrees and 90 degrees from on-axis. As can be seen, the maximum drop in amplitude is 2 dB down from the on-axis level from 125 Hz to 8 kHz and −4 dB between 125 Hz to 18 kHz at 90 degrees off-axis.

In addition, the signal-to-noise ratio is maximized in the exemplary embodiment by minimizing the length of the internal conductor 109 and using a transmission interface 103 having a signal conductor 108 for the electrical signal and a separate supply conductor for supply signals.

Clearly, other embodiments and modifications of this invention will occur readily to those of ordinary skill in the art in view of these teachings. Therefore, this invention is to be limited only by following claims, which include all such embodiments and modifications when viewed in conjunction with the above specification and accompanying drawings.

I claim:

1. A sound capture device:
a transducer;
a supply conductor for conveying a supply signal to the transducer; and
a signal conductor for conveying an electrical signal produced by the transducer in response to a sound pressure wave.

2. A sound capture device in accordance with claim 1, further comprising:
an amplifier connected between the transducer and the signal conductor, the signal conductor conveying an amplified electrical signal produced by the amplifier in response to the electrical signal.

3. A sound capture device in accordance with claim 2, further comprising an internal conductor connected between an electrical signal output of the transducer and an amplifier input of the amplifier, the internal conductor having an internal conductor length less than a signal conductor length of the signal conductor.

4. A sound capture device in accordance with claim 3, wherein the internal conductor length is less than one tenth of the signal conductor length.

5. A sound capture device in accordance with claim 4, wherein the internal conductor length is less than one one-hundredth of the signal conductor length.

6. A sound capture device in accordance with claim 2, wherein the amplifier comprises a plurality of amplification stages having power gains greater than one.

7. A sound capture device in accordance with claim 6, wherein the power gains are greater than 10 dB.

8. A sound capture device in accordance with claim 7, wherein the power gains are greater than 15 dB.

9. A sound capture device in accordance with claim 8, wherein the plurality of amplification stages comprise exactly two amplification stages.

10. A sound capture device in accordance with claim 1, further comprising a transmission interface for housing the supply conductor and the signal conductor.

11. A sound capture device in accordance with claim 10, wherein the transmission interface comprises a plurality of transmission interface cables, the signal conductor housed within a first interface cable and the supply conductor housed within a second interface cable.

12. A sound capture device in accordance with claim 11, wherein the transmission interface comprises:
a supply interface cable comprising a positive supply conductor, a negative supply conductor and a common supply conductor; and
a signal interface cable comprising a first signal conductor, a second signal conductor, and a common signal conductor.

13. A sound capture device in accordance with claim 12, wherein the common signal conductor is a shield encompassing the first signal conductor and the second signal conductor.

14. A sound capture device in accordance with claim 10, wherein the transmission interface, the supply conductor and the signal conductor form a single transmission interface cable.

15. A sound capture device in accordance with claim 1, further comprising:
another transducer producing another electrical signal in response to the sound pressure wave;
another a signal conductor for conveying the another electrical signal.

16. A sound capture device in accordance with claim 15, further comprising:
another amplifier connected between the another transducer and the another signal conductor, the another signal conductor conveying another amplified electrical signal produced by the another amplifier in response to the another electrical signal.

17. A sound capture device in accordance with claim 16, wherein the another transducer is separated from the transducer at a separation distance in accordance sound reception at human ears on a human head facing a sound source.

18. A sound capture device in accordance with claim 17, wherein the separation distance is between 10 and 14 inches.

19. A sound capture device in accordance with claim 18, wherein the separation distance is between 11 and 13 inches.

20. A sound capture device in accordance with claim 19, wherein the separation distance is approximately 12 inches.

21. A sound capture device in accordance with claim 17, wherein the transducers are positioned to form an angle between an axis of the transducer and an axis of the another transducer between 15 and 45 degrees.

22. A sound capture device in accordance with claim 21, wherein the angle is between 25 and 35 degrees.

23. A sound capture device in accordance with claim 22, wherein the angle is approximately 30 degrees.

24. A sound capture device comprising:
a transducer for producing an electrical signal in response to a sound pressure wave; and
an amplifier for amplifying the electrical signal to produce an amplified electrical signal, the amplifier co-located with the transducer and comprising a plurality of amplification stages having power gains greater than one.

25. A sound capture device in accordance with claim 24, further comprising:
a power input configured to connect to a supply conductor of a transmission interface; and
a signal output configured to connect to a signal conductor of the transmission interface.

26. A sound capture device in accordance with claim 25, further comprising an internal signal conductor connected between an electrical signal output of the transducer and an amplifier input of the amplifier, the internal conductor having a internal conductor length less than a signal conductor length of the signal conductor.

27. A sound capture device in accordance with claim 26, wherein the internal conductor length is less than one tenth of the signal conductor length.

28. A sound capture device in accordance with claim 27, wherein the internal conductor length is less than one one-hundredth of the signal conductor length.

29. A sound capture device in accordance with claim 24, wherein the power gains are greater than 10 dB.

30. A sound capture device in accordance with claim 29, wherein the power gains are greater than 15 dB.

31. A sound capture device in accordance with claim 30, wherein the plurality of amplification stages comprise exactly two amplification stages.

32. A sound capture device in accordance with claim 25, wherein the transmission interface, the supply conductor and the signal conductor form a transmission interface cable.

33. A sound capture device in accordance with claim 32, wherein the transmission interface comprises a plurality of transmission interface cables, the signal conductor housed within a first interface cable and the supply conductor housed within a second interface cable.

34. A sound capture device in accordance with claim 33, wherein the transmission interface comprises:
a supply interface cable comprising a positive supply conductor, a negative supply conductor and a common supply conductor; and
a signal interface cable comprising a first signal conductor, a second signal conductor, and a common signal conductor.

35. A sound capture device in accordance with claim 34, wherein the common signal conductor is a shield encompassing the first signal conductor and the second signal conductor.

36. A sound capture device in accordance with claim 24, further comprising:
another transducer producing another electrical signal in response to the sound pressure wave; and
another signal output configured to connect to another signal conductor for conveying the another electrical signal.

37. A sound capture device in accordance with claim 36, further comprising another amplifier connected between the another transducer and the another signal output.

38. A sound capture device in accordance with claim 37, wherein the another transducer is separated from the transducer at a separation distance in accordance with sound reception at human ears on a human head facing a sound source.

39. A sound capture device in accordance with claim 38, wherein the separation distance is between 10 and 14 inches.

40. A sound capture device in accordance with claim 39, wherein the separation distance is between 11 and 13 inches.

41. A sound capture device in accordance with claim 40, wherein the separation distance is approximately 12 inches.

42. A sound capture device in accordance with claim 38, wherein the transducers are positioned to form an angle between an axis of the transducer and an axis of the another transducer between 15 and 45 degrees.

43. A sound capture device in accordance with claim 42, wherein the angle is between 25 and 35 degrees.

44. A sound capture device in accordance with claim 43, wherein the angle is approximately 30 degrees.

45. A sound capture device comprising:
a transducer for producing an electrical signal at an electrical signal output in response to a sound pressure wave received at a transducer sound input;
an amplifier comprising a plurality of amplification stages having power gains greater than one and an amplifier input connected to the electrical signal output through an internal signal conductor, the amplifier producing an amplified electrical signal at an amplifier output in response to the electrical signal;
a supply interface cable comprising at least one supply conductor for conveying electrical power to the transducer and to the amplifier; and
a signal interface cable comprising at signal conductor in electrical communication with the amplifier output, the internal signal conductor having an internal conductor length less than a signal conductor length of the signal conductor.

46. A sound capture device in accordance with claim 45, wherein the internal conductor length is less than one tenth of the signal conductor length.

47. A sound capture device in accordance with claim 46, wherein the internal conductor length is less than one one-hundredth of the signal conductor length.

48. A sound capture device in accordance with claim 45, wherein the power gains are greater than 10 dB.

49. A sound capture device in accordance with claim 48, wherein the power gains are greater than 15 dB.

50. A sound capture device in accordance with claim 45, wherein the plurality of amplification stages comprise exactly two amplification stages.

51. A sound capture device comprising:
a first transducer; and
a second transducer positioned at a separation distance from the first transducer, the separation distance in accordance with sound reception at human ears on a human head facing a sound source.

52. A sound capture device in accordance with claim 51, wherein the separation distance is between 10 and 14 inches.

53. A sound capture device in accordance with claim 52, wherein the separation distance is between 11 and 13 inches.

54. A sound capture device in accordance with claim 53, wherein the separation distance is approximately 12 inches.

55. A sound capture device in accordance with claim 51, wherein the transducers are positioned to form an angle between an axis of the first transducer and an axis of the second transducer between 15 and 45 degrees.

56. A sound capture device in accordance with claim 55, wherein the angle is between 25 and 35 degrees.

57. A sound capture device in accordance with claim 56, wherein the angle is approximately 30 degrees.

58. A method comprising:
receiving electrical power at a transducer through at least one supply conductor;
producing an electrical signal in response to a received sound signal;
transmitting the electrical signal through an internal signal conductor to an amplifier;
amplifying the electrical signal to produce an amplified electrical signal; and
transmitting the amplified electrical signal through a signal conductor.

59. A method in accordance with claim 58, wherein the amplifying comprises:
amplifying the electrical signal through a plurality of amplification stages.

60. A method in accordance with claim 59, wherein the amplifying comprises:
amplifying the electrical signal to a first amplitude to form a partially amplified signal; and
amplifying the partially amplified signal to a second amplitude to form the amplified electrical signal.

61. A method in accordance with claim 58, wherein the amplifying comprises:
amplifying the electrical signal to form the amplified electrical signal having a line level voltage.

62. A method in accordance with claim 61, wherein the amplifying comprises:
amplifying the electrical signal to form the amplified electrical signal having a root mean square (RMS) voltage level between 2 and 6 volts.

63. A method in accordance with claim 58, wherein the transmitting the amplified electrical signal comprises transmitting the amplified electrical signal through the signal conductor having a signal conductor length greater than an internal conductor length of the internal conductor.
